(19) United States
(12) Patent Application Publication
(10) Pub. No.: US 2021/0160273 A1
(43) Pub. Date: May 27, 2021

(54) METHOD FOR CALCULATING RISK FOR INDUSTRIAL CONTROL SYSTEM AND APPARATUS USING THE SAME

(71) Applicant: ELECTRONICS AND TELECOMMUNICATIONS RESEARCH INSTITUTE, Daejeon (KR)

(72) Inventors: Yang-Seo CHOI, Daejeon (KR); Won-Jun SONG, Daejeon (KR); Gae-Il AN, Daejeon (KR)

(73) Assignee: ELECTRONICS AND TELECOMMUNICATIONS RESEARCH INSTITUTE, Daejeon (KR)

(21) Appl. No.: 17/081,414

(22) Filed: Oct. 27, 2020

(30) Foreign Application Priority Data
Nov. 22, 2019 (KR) 10-2019-0151489

(51) Int. Cl. H04L 29/06; G05B 19/4155

(52) U.S. Cl. CPC H04L 63/1433; G05B 2219/31449; G05B 19/4155

(57) ABSTRACT

Disclosed herein are a method for calculating a risk for an industrial control system and an apparatus for the same. The method includes collecting at least one keyword based on published vulnerabilities in a target industrial control system and generating an attack vector corresponding to the at least one keyword; collecting operating environment characteristics corresponding to the operating environment that is currently being used in the target industrial control system; calculating a targeted risk for the attack vector in consideration of a vulnerability characteristic matching the at least one keyword, among the operating environment characteristics, and a weight applied to the vulnerability characteristic; and providing the targeted risk to the operator module of the target industrial control system.

### CROSS REFERENCE TO RELATED APPLICATION

This application claims the benefit of Korean Patent Application No. 10-2019-0151489, filed on Nov. 22, 2019, which is hereby incorporated by reference in its entirety into this application.

### BACKGROUND OF THE INVENTION

### 1. Technical Field

The present invention relates generally to technology for calculating a risk for an industrial control system, and more particularly to technology for enabling the operator of an industrial control system, which is used in various industrial environments, such as factories, hospitals, power plants, and the like, to be easily and accurately made aware of the extent of the risk of a newly published vulnerability capable of affecting the industrial control system.

### 2. Description of the Related Art

Industrial systems, such as Programmable Logic Controllers (PLC), Distributed Control Systems (DCS), and the like, are used in manufacturing industry sites, power plants, and various other fields related to finance, national defense, public safety, communication, transportation, and the like. The purpose of operation of industrial systems and an operation method and an operating system used therein are different from those of servers or personal computer systems, which are widely used in the existing Internet environment, and these industrial systems are mainly used in social infrastructure facilities, large-scale factories, and the like.

Industrial systems are widely used in various fields, but have been able to avoid being subjected to various types of invasive behavior because they are operated on separate networks, unlike general computers such as existing PCs or servers, and because operating systems used therein are not common operating systems.

However, various forms of attacks illustrated in FIG. 1 have recently been attempted on industrial systems. Particularly, it was confirmed through the incident of hacking of the system of Korea Hydro and Nuclear Power in 2014 that a security threat to industrial systems has been realized. The internal network related to nuclear energy in the system of Korea Hydro and Nuclear Power was hacked even though network separation and state-of-the-art security technology were applied thereto, and this incident therefore became a social issue in South Korea. Further, this incident shows that a threat to national security, which is very sensitive in South Korea due to the military situation with North Korea, was embodied and realized.

In this situation, quickly detecting the effects of newly discovered vulnerabilities on currently running industrial systems becomes more important in order to protect the industrial systems. To this end, it is necessary to deliver information about how newly discovered vulnerabilities can be exploited for an attack and to quantify the risk thereof and announce the same such that general users are aware of the risk. However, because most conventional methods for calculating risk are developed for IT systems, it is difficult to apply these methods to the operating environment of industrial control systems.

A representative one of the conventional methods is a Common Vulnerability Scoring System (CVSS), which is currently at version 3.1. Referring to FIG. 4, the CVSS is configured with a base metric group, a temporal metric group, and an environmental metric group, but when a vulnerability is first published, only base metrics therefor are written and published, and the characteristics of the operating environment of the system actually having the vulnerability are not reflected therein. Also, although metrics for reflecting the characteristics of the operating environment are provided through environmental metrics, the severity scores thereof are calculated without regard for the base metrics. In this case, when the environmental metrics are used, the basic characteristics of a specific vulnerability are not incorporated therein at all. Also, each company or organization that operates a system needs to rewrite environmental metrics for the corresponding vulnerability itself, but in this process, environmental characteristics are represented in an abstract manner, thus the information cannot be used in an appropriate manner.

Unlike systems operating in the existing IT environment, a system operating in an industrial control environment may not be affected by a vulnerability depending on the operating environment of the system even though an application of the same version as the version in which the corresponding vulnerability is found is running on the system. For example, a certain vulnerability may be present in an application provided over a network, but when an industrial control system in which the corresponding application is run is designed so as to physically disable network communication, the corresponding vulnerability may be regarded as not existing in the industrial control system.

As described above, because the characteristics of the operating environment of an industrial control system are very important information that is used to determine whether a vulnerability is capable of actually affecting the industrial control system, an operator who actually operates the system requires an automated risk calculation method in which these characteristics are reflected.

### DOCUMENTS OF RELATED ART

(Patent Document 1) Korean Patent No. 10-1442691, registered on Sep. 15, 2014 and titled “Apparatus and method for quantifying vulnerability of system”

### SUMMARY OF THE INVENTION

An object of the present invention is to calculate a realistic risk of a newly discovered vulnerability by reflecting the characteristics of the operating environment of the industrial control system that is currently being operated.

Another object of the present invention is to provide information about how a newly discovered vulnerability can be exploited for an attack in an industrial control system and to quantify the risk thereof by taking the characteristics of the operating environment of the industrial control system into account in order to make general users aware of the risk.

A further object of the present invention is to enable the operator of an industrial control system to intuitively recognize the expected effect of a new vulnerability on the corresponding system.

Yet another object of the present invention is to easily detect an operating environment that is more likely to be exposed to risk when a vulnerability is exploited and to significantly reduce the amount of resources to be consumed for elimination of the vulnerability.

In order to accomplish the above objects, a method for calculating a risk for an industrial control system according to the present invention includes collecting at least one keyword based on a published vulnerability and generating an attack vector corresponding to the at least one keyword; collecting operating environment characteristics corresponding to an operating environment that is currently being used in a target industrial control system; calculating a targeted risk for the attack vector in consideration of a vulnerability characteristic matching the at least one keyword, among the operating environment characteristics, and a weight applied to the vulnerability characteristic; and providing the targeted risk to the operator module of the target industrial control system.

Here, the at least one keyword may be extracted from the published vulnerability based on parameters used in a predefined Common Vulnerability Scoring System (CVSS).

Here, the published vulnerability may include at least one of a method for accessing a vulnerability target, the vulnerability target, and detailed information of the vulnerability target.

Here, the targeted risk may be calculated so as to correspond to an attack path capable of being derived based on the vulnerability characteristic.

Here, the weight may be a weight applied to an operating environment characteristic corresponding to the vulnerability characteristic, among weights applied for the respective operating environment characteristics.

Here, the targeted risk may be calculated by adding a first risk, which is calculated by applying the weight applied to the vulnerability characteristic to a general risk attributable to the published vulnerability, and a second risk, which is a potential risk in which a weight applied to each of the operating environment characteristics is taken into account.

Here, the operating environment characteristics may be defined in consideration of the parameters used in the predefined CVSS such that whether the operating environment characteristics match the at least one keyword is determined.

Here, the at least one keyword may include at least one of manufacturer information, product information, product version information, and description information.

Here, the method may further include, when a vulnerability characteristic matching the at least one keyword is not present, among the operating environment characteristics, determining that the published vulnerability poses no risk to the target industrial control system.

Also, an apparatus for calculating a risk for an industrial control system according to an embodiment of the present invention includes a processor for collecting at least one keyword based on a published vulnerability, generating an attack vector corresponding to the at least one keyword, collecting operating environment characteristics corresponding to an operating environment that is currently being used in a target industrial control system, calculating a targeted risk for the attack vector in consideration of a vulnerability characteristic matching the at least one keyword, among the operating environment characteristics, and a weight applied to the vulnerability characteristic, and providing the targeted risk to the operator module of the target industrial control system; and memory for storing the attack vector and the operating environment characteristics.

Here, the at least one keyword may be extracted from the published vulnerability based on parameters used in a predefined Common Vulnerability Scoring System (CVSS).

Here, the published vulnerability may include at least one of a method for accessing a vulnerability target, the vulnerability target, and detailed information of the vulnerability target.

Here, the targeted risk may be calculated so as to correspond to an attack path capable of being derived based on the vulnerability characteristic.

Here, the weight may be a weight applied to an operating environment characteristic corresponding to the vulnerability characteristic, among weights applied for the respective operating environment characteristics.

Here, the targeted risk may be calculated by adding a first risk, which is calculated by applying the weight applied to the vulnerability characteristic to a general risk attributable to the published vulnerability, and a second risk, which is a potential risk in which a weight applied to each of the operating environment characteristics is taken into account.

Here, the operating environment characteristics may be defined in consideration of the parameters used in the predefined CVSS such that whether the operating environment characteristics match the at least one keyword is determined.

Here, the at least one keyword may include at least one of manufacturer information, product information, product version information, and description information.

Here, when a vulnerability characteristic matching the at least one keyword is not present, among the operating environment characteristics, the processor may determine that the published vulnerability poses no risk to the target industrial control system.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a view illustrating an example of a major attack path to an industrial control system;

FIG. 2 is a flowchart illustrating a system for calculating a risk for an industrial control system according to an embodiment of the present invention;

FIG. 3 is a flowchart illustrating a method for calculating a risk for an industrial control system according to an embodiment of the present invention;

FIG. 4 is a view illustrating an example of risk measurement metrics of a CVSS;

FIGS. 5 to 8 are views illustrating an example of vulnerability information that is generally provided in an NVD;

FIG. 9 is a flowchart specifically illustrating the process of calculating a risk for an industrial control system according to an embodiment of the present invention; and

FIG. 10 is a block diagram illustrating an apparatus for calculating a risk for an industrial control system according to an embodiment of the present invention.

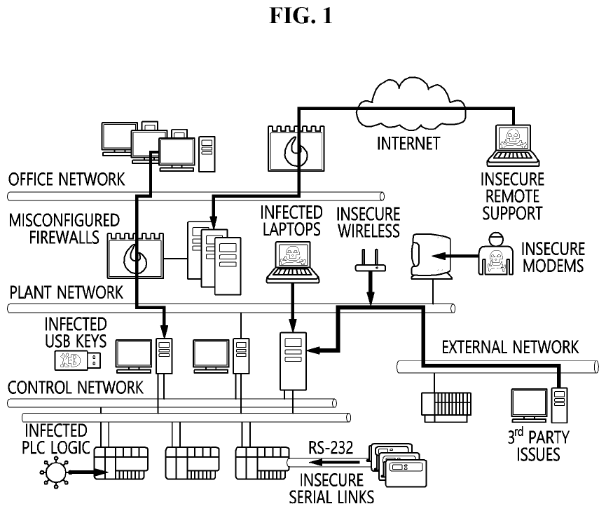

### DESCRIPTION OF THE PREFERRED EMBODIMENTS

The present invention will be described in detail below with reference to the accompanying drawings. Repeated descriptions and descriptions of known functions and configurations that have been deemed to unnecessarily obscure the gist of the present invention will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

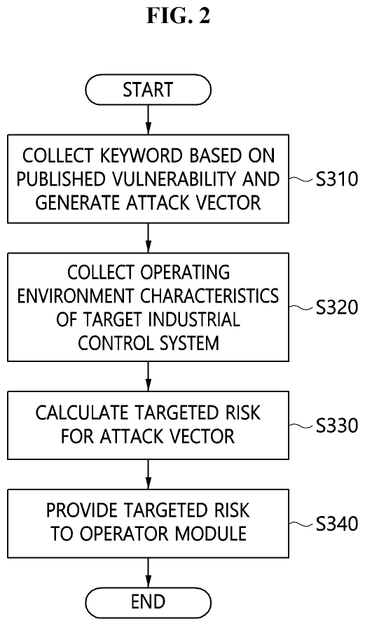

FIG. 2 is a flowchart illustrating a system for calculating a risk for an industrial control system according to an embodiment of the present invention.

Referring to FIG. 2, the industrial control system according to an embodiment of the present invention includes a risk calculation apparatus 200, vulnerability information 201, and a monitoring system 202 of an operator.

The core technology of the present invention is to derive an attack vector for an actual industrial control system from the vulnerability information 201 published on the Internet based on a keyword, to calculate a risk related to the effect of the corresponding attack vector on the industrial control system that is currently being operated, and to provide the same to the monitoring system 202 of the operator, thereby helping the operator decide on measures to take in order to maintain the stability of the system.

To this end, the risk calculation apparatus 200 includes a vulnerability information collection module 210, a vulnerability-information-parsing module 220, an attack vector generation module 230, a vulnerability search module 240, an ICS system operating environment characteristic collection module 250, a risk calculation module 260, and a database 270, as shown in FIG. 2.

The vulnerability information collection module 210 may collect vulnerability information 201 through the Internet in a periodic or aperiodic manner, and may parse the collected vulnerability information 201 through the vulnerability-information-parsing module 220 and transmit the same to the attack vector generation module 230.

Then, the attack vector generation module 230 may generate an attack vector including a path related to steps that need to be performed in order for an attack using the published vulnerability to succeed, and may store the attack vector in the database 270.

Then, the vulnerability search module 240 searches the database 270 based on a keyword related to the target industrial control system, for which the risk is to be calculated, thereby identifying relevant vulnerabilities therein. Here, the keyword related to the target industrial control system may be selected based on the characteristics of the operating environment, which are collected from the target industrial control system through the ICS system operating environment characteristic collection module 250.

Then, in consideration of a vulnerability characteristic that matches the keyword used for the search, that is, the keyword related to the published vulnerability, among the characteristics of the operating environment of the target industrial control system, and in further consideration of the weight applied to the vulnerability characteristic, the risk calculation module 260 may calculate a targeted risk.

Here, ‘targeted risk’ denotes the actual effect of the attack vector on the target industrial control system, and the value of the targeted risk may vary depending on the characteristics of the operating environment of the target that is attacked by the attack vector.

The targeted risk calculated as described above is delivered to the monitoring system 202 of the operator of the target industrial control system, thereby helping operators intuitively recognize an actual risk to an industrial control system being operated by the operators.

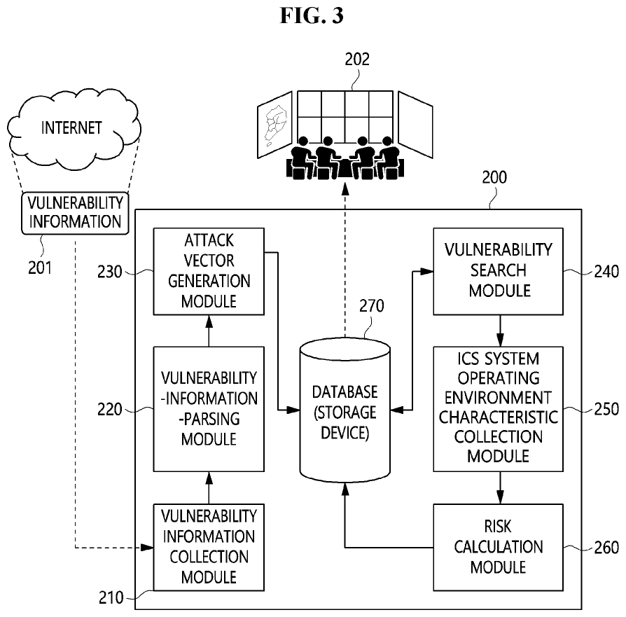

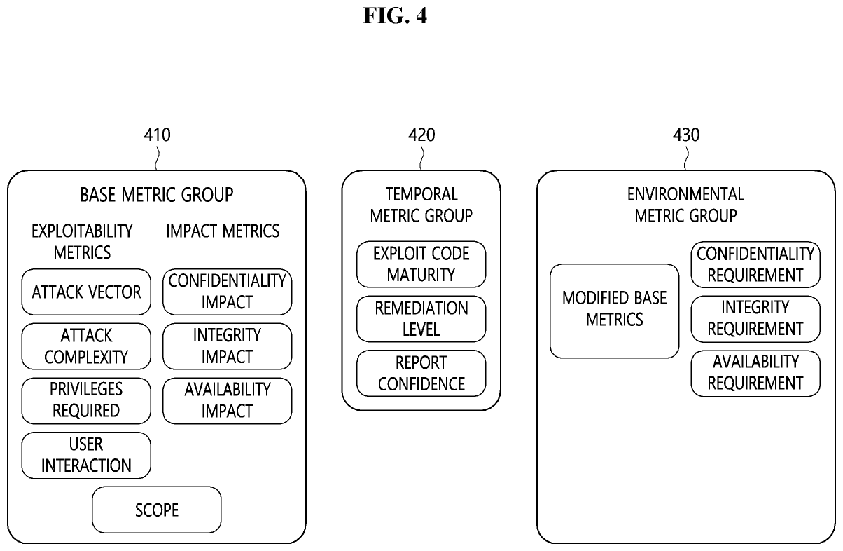

FIG. 3 is a flowchart illustrating a method for calculating a risk for an industrial control system according to an embodiment of the present invention.

Referring to FIG. 3, in the method for calculating a risk for an industrial control system according to an embodiment of the present invention, at least one keyword is collected based on published vulnerabilities, and an attack vector corresponding to the at least one keyword is generated at step S310.

Here, the published vulnerabilities may be automatically collected through the Internet in a periodic or aperiodic manner. For example, vulnerability information provided by various organizations, including a National Vulnerability Database (NVD) managed by the National Institute of Standards and Technology (NIST) in the U.S., may be collected.

Here, because the collected vulnerability information may have various forms and formats, the vulnerability collected through the Internet may be parsed to take a form from which a keyword can be extracted. For example, in the present invention, the vulnerability information may be processed in a JSON or CSV format.

Here, the attack vector defined in the present invention may include information about the steps that need to be performed in order for an attack using the published vulnerability to succeed. This concept is autonomously defined, developed and used in the present invention, and may have definition different from that of a concept having a similar name.

Accordingly, the present invention may use a vulnerability target, description information about the vulnerability itself, and the risk of the vulnerability, which are included in the parsed vulnerability information, as important information for generating an attack vector.

Here, the at least one keyword may be extracted from the published vulnerability based on parameters used in the predefined Common Vulnerability Scoring System (CVSS).

Here, the published vulnerability may include at least one of a method for accessing a vulnerability target, the vulnerability target, and detailed information on the vulnerability target.

Here, the at least one keyword may include at least one of manufacturer information, product information, product version information, and description information.

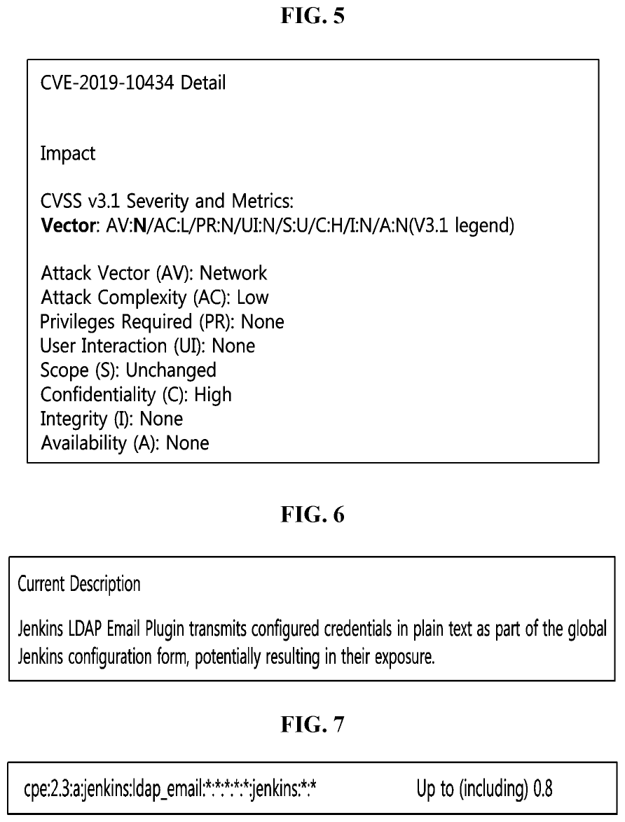

For example, vulnerability information published by the National Vulnerability Database (NVD) may generally include a CVE number, a detailed description, a risk level, and information about targets (an operating system, a service, an application, and the like) in which the vulnerability is present, as shown in FIG. 5. Here, the ‘vector’ illustrated in FIG. 5 corresponds to the concept defined and used by the CVSS, and may be different from the attack vector automatically generated in the present invention.

Here, the information capable of being identified in FIG. 5 is the fact that the corresponding vulnerability relates to an attack attempted over a network (AV:N), that is, information about the method of accessing the vulnerability target. Here, this information is insufficient to determine to what extent the vulnerability will actually affect a specific device. However, the present invention may extract the information about the access method, which tells that an attack using the corresponding vulnerability is attempted over a network, as a keyword and use the same for generating an attack vector.

In other words, the AV (attack vector) of the CVSS denotes the access method that is used in order to make an attack succeed, and may have any of four values indicating N (Network), A (Adjacent), L (Local) and P (Physical). In the present invention, these values may be extracted as keywords that are to be used for generating an attack vector.

In another example, the information illustrated in FIG. 6 relates to a description of the vulnerability itself included in the published vulnerability, and keywords related to vulnerable applications or services, that is, keywords related to the vulnerability target, may be extracted therefrom. Referring to the information illustrated in FIG. 6, a Jenkins LDAP Email Plugin is detected as a vulnerability target, and the corresponding information may be extracted as a keyword.

In another example, the information illustrated in FIG. 7 is detailed information on the vulnerability target, and based on the information illustrated in FIG. 7, information such as the name and version of the vulnerable application may be extracted as keywords.

As described above, using the keywords extracted from the information in FIGS. 5 to 7, an attack vector indicating that an attack on a specific version of a Jenkins LDAP email plugin can be attempted over a network and that a configuration problem may result therefrom, may be generated, and this attack vector may be represented as ‘N<-PI<-LL’.

Here, N indicates that the value of the vector provided by the vulnerability is a network, and PI (Physical Interface) and LL (Logical Location) will be described in detail later when the characteristics of the operating environment of an industrial control system are described.

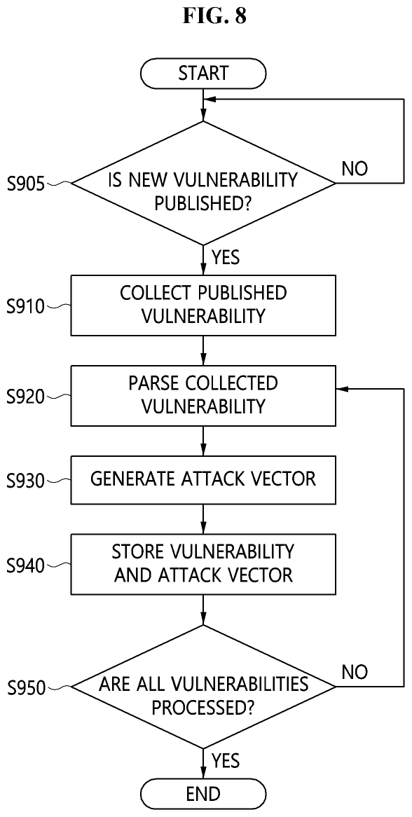

FIG. 8 is another example of a published vulnerability, which is different from the example of FIGS. 5 to 7, and the attack vector generated using the vulnerability information illustrated in FIG. 8 may be defined as ‘P<-PI<-PL’. According to this attack vector, because physical access must be possible and a serial port must be provided, the physical location of the actually operated industrial control system may be an important factor for determining the validity of the attack vector.

As described above, the process of generating an attack vector may be performed automatically, and the characteristics matching each keyword collected from the published vulnerability may be continuously updated, whereby a more accurate attack vector may be generated.

Also, in the method for calculating a risk for an industrial control system according to an embodiment of the present invention, the characteristics of the operating environment that is currently being used in the target industrial control system are collected at step S320.

For example, even if an application of the same version as the version in which a vulnerability is present is running in the industrial control system, the system may not be vulnerable depending on the environment in which the corresponding system is operated. Therefore, in order to reflect this, the present invention may use the characteristics of the operating environment of the target industrial control system.

For example, the characteristics of the operating environment in which an industrial control system is operated may be classified as shown in the following [Table 1].

TABLE 1
Whether vulnerable service is provided in CDA (VS: Vulnerable Service)
Whether a vulnerable service stated in a vulnerability is being used
Whether CDA login service is provided (LS: Login Service)
Whether CDA remote access login is possible
Whether CDA console login is possible
Physical network interface (PI: Physical Interface)
A general network, a wireless network, serial communication,
unidirectional communication, and a sensor network
Whether each network interface is enabled
Whether physical access to the network interface is blocked
CDA physical operation location (PL: Physical Location)
PA (Protected Area): protected using a physical barrier
VA (Vital Area): protected through access control while being PA
Offsite: outside a powerplant
Whether a locking device for CDA is maintained,
whether people who attempt
access are authenticated, and whether access control is capable of being
provided
Logical operation location on CDA network (LL: Logical Location)
Is a CDA network interface accessible from another level?
Low -> High
High -> Low
Is an access control method applied when access to CDA is enabled?
System, software, and the like (unidirectional access, a firewall,
and the like)
Portable media and device control (PM: Portable Media)
Whether an interface enabling access is present when physical
access is enabled
(USB, SD card, CD, and the like)
Is access through a physical interface disabled using a physical means?
Is an existing physical access interface disabled using software?
Is there a device for controlling and identifying physical access?
Supply chain control (SC: Supply chain)
Is all installed and running software verified/certified?
Is software patched and updated after verification?
Is remote access by a CDA supplier enabled?
Are records on installation and operation of software running on CDA and
software update maintained?
Is management continuity provided in the event of migration of CDA?
Possibility of connection with other system (OS: Other system)
Is CDA capable of being connected with other systems over a
network or the like?
Whether HMI for the corresponding CDA is present
Whether access to EWS for the corresponding CDA is possible

Here, the operating environment characteristics may be defined in consideration of parameters used in the predefined CVSS such that whether the operating environment characteristics match at least one keyword is determined.

For example, the operating environment characteristics described in [Table 1] may be represented as VS, LS, PI, PL, LL, PM, SC and OS, respectively, and N, A, L and P used in the vector included in the corresponding vulnerability information may be used therewith.

When the attack vector ‘N<-PI<-LL’ derived from the information illustrated in FIGS. 5 to 7 is analyzed based on the above characteristics, it will be understood that the corresponding attack vector is able to attack and affect an industrial control system when the industrial control system has operating environment characteristics in which a physical network interface (PI) is present and in which the system is accessible over a network (LL).

Also, although not illustrated in FIG. 3, in the method for calculating a risk for an industrial control system according to an embodiment of the present invention, vulnerabilities capable of affecting the target industrial control system may be searched for using keywords related to the characteristics of the operating environment of the target industrial control system. Here, the keyword to be used for the search may include at least one of manufacturer information, product information, product version information, and description information, similar to the keyword that is extracted from the vulnerability in order to generate an attack vector.

Accordingly, the manufacturer information, the product information, and the product version information may be retrieved based on the vulnerability target included in the published vulnerability, and the description information may be retrieved based on the detailed information of the vulnerability target included in the published vulnerability. Through such retrieval, vulnerabilities capable of affecting the target industrial control system are identified, and the risk thereof may be calculated.

Also, in the method for calculating a risk for an industrial control system according to an embodiment of the present invention, the targeted risk of the attack vector is calculated at step S330 in consideration of a vulnerability characteristic matching at least one keyword, among the operating environment characteristics, and a weight applied to the vulnerability characteristic.

Here, the targeted risk may be calculated so as to correspond to an attack path capable of being derived based on the vulnerability characteristic.

Here, the weight may be the weight applied to the operating environment characteristic corresponding to the vulnerability characteristic, among weights applied for the respective operating environment characteristics.

For example, the weights for the respective operating environment characteristics may be assigned as shown in [Table 2].

TABLE 2

| Whether vulnerable service is provided in CDA (VS: Vulnerable Service) | |
|---|---|
| when neither of a vulnerable service and a relevant item is provided | 0 |
| when a vulnerable service or a relevant item is provided | 1 |
| Whether CDA login service is provided (LS: Login Service) | |
| when remote access login is possible | 1 |
| when console login is possible | 1 |
| when neither of the above two options is possible | 0.5 |
| Physical network interface (PI: Physical Interface) | |
| when AV of CVE is N, A or L, | 1 |
| when an interface is a general network and a wireless network, | |
| when a network interface is enabled, and | |
| when physical access to the interface is not blocked | |
| when AV of CVE is P and serial communication, | 1 |
| when an interface is enabled, and | |
| when physical access to the interface is not blocked | |
| unidirectional communication | 0.25 |
| a sensor network | 0.25 |
| other | 0.25 |
| CDA physical operation location (PL: Physical Location) | |
| PA (Protected Area) | 0.7 |
| VA (Vital Area) | 0.5 |
| Offsite | 1 |

among the conditions of whether a locking device for CDA is maintained, whether
to authenticate people who attempt access, and whether access control is capable of
being provided,
when one condition is satisfied, the above values are changed to 0.5, 0.3 and 0.7
when two conditions are satisfied, the above values are changed to 0.3, 0.2 and 0.5
when three conditions are satisfied, the above values are changed to 0.1, 0.1 and 0.3

| | |
|---|---|
| Logical operation location on CDA network (LL: Logical Location) | |
| when a network interface is accessible from another level and | 1 |
| when no access control method is applied | |
| when a network interface is accessible from another level and | 0.6 |
| when an access control method is applied | |
| when a network interface is inaccessible from another level and | 0.7 |
| when no access control method is applied | |
| when a network interface is inaccessible from another level and | 0.3 |
| when an access control method is applied | |
| Portable media and device control (PM: Portable Media) | |
| when a portable storage device interface is present, | 1 |
| when access thereto is not physically disabled, | |
| when access thereto is not disabled using software, and | |
| when a device for controlling and identifying the portable storage | |
| device is not present | |
| when a portable storage device interface is present, | 0.5 |
| when access thereto is not physically disabled, | |
| when access thereto is not disabled using software, and | |
| when a device for controlling and identifying the portable storage device is | |
| present | |
| when no portable storage device interface is present, | 0.1 |
| when access thereto is physically disabled, or | |
| when access thereto is disabled using software | |
| Supply chain control (SC: Supply chain) | |
| when not all installed and running software is verified/authenticated or | 1.0 |
| when software is patched or updated without verification | |
| when remote access by a CDA supplier is enabled | 1.0 |
| when records on installation and operation of software running on CDA and | 1.0 |
| software update are not maintained | |
| when management continuity is not provided in the event of | 1.0 |
| migration of CDA | |
| other | 0.1 |
| Possibility of connection with other system (OS: Other system) | |
| when CDA is capable of being connected with other systems over | 1.0 |
| a network or the like | |
| when HMI for the corresponding CDA is present | 0.5 |
| when access to EWS for the corresponding CDA is possible | 0.5 |
| other | 0.1 |

Here, the targeted risk may be calculated by adding a first risk, which is calculated by applying the weight applied to the vulnerability characteristic to a general risk attributable to the published vulnerability, and a second risk, which is a potential risk in which the weight applied for each operating environment characteristic is taken into account.

For example, when it is assumed that the first risk is an operational risk score and that the second risk is a potential risk score, the first risk and the second risk may be calculated using Equation (1) and Equation (2), respectively.

AV: N or A

AttackVector*VS*PI*LL

AV: L (the larger value among the following values)

AttackVector*VS*LS*PI*LL

AttackVector*VS*LS*PI*PL

AV: P

AttackVector*VS*PL (1)

w0PM+w1SC+w2OS (2)

Here, the first risk is a value acquired by calculating the risk directly associated with the published vulnerability, and the second risk, which is a potential risk, may be a value acquired by calculating a risk in the situation in which a vulnerable application or service is actually present and there is a high possibility of the risk.

Accordingly, based on the respectively calculated risks, the AttackVector of the finally calculated risk score of the CVSS is replaced, whereby the targeted risk may be finally calculated.

For example, the method of finally calculating a targeted risk by replacing the AttackVector with the risk of each characteristic (characteristic risk) in order to calculate a base score using the method proposed by the present invention may be represented as shown in Equation (3):

8.22*CharacteristicRisk*AttackComplexity*PrivilegeRequired*UserInteraction (3)

Here, values included in vulnerability information provided by the NVD may be used for AttackComplexity, PrivilegeRequired, and UserInteraction.

Also, in the method for calculating a risk for an industrial control system according to an embodiment of the present invention, the targeted risk is provided to the operator module of the target industrial control system at step S340.

Because the targeted risk provided through the above-described method reflects all of the characteristics of the operating environment of the target industrial control system therein while retaining the characteristics of the discovered vulnerability itself, it may be very useful in determining whether it is necessary to take a measure in the corresponding operating environment in response to a specific vulnerability.

Also, although not illustrated in FIG. 3, in the method for calculating a risk for an industrial control system according to an embodiment of the present invention, when a vulnerability characteristic matching the at least one keyword is not present, among the operating environment characteristics, the published vulnerability may be determined to pose no risk to the target industrial control system.

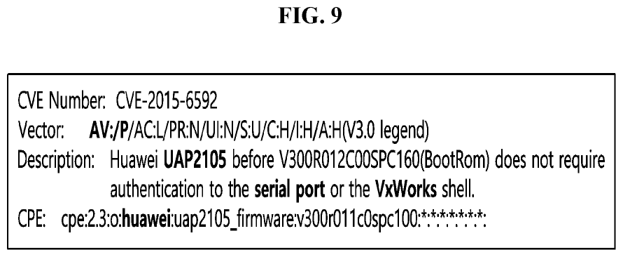

Also, the above-described process of calculating a risk is specifically illustrated in FIG. 9.

Referring to FIG. 9, first, whether new vulnerabilities are published may be determined at step S905. When no new vulnerability is published, the publication of a new vulnerability may be waited for.

Also, when it is determined at step S905 that new vulnerabilities are published, the published vulnerabilities are collected by downloading a list of the vulnerabilities at step S910, the collected vulnerabilities are parsed at step S920, and an attack vector and a main keyword may be extracted for each of the vulnerabilities.

Using the extracted attack vector and main keyword, an attack vector as defined in the present invention is generated at step S930, and the generated attack vector may be stored in the database along with the vulnerability at step S940. This process may be performed for all of the newly published vulnerabilities.

That is, whether the above process is performed for all of the newly published vulnerabilities is determined at step S950, and when the above process has not been performed for all of the newly published vulnerabilities, the process may be repeatedly performed from step S920.

Through this process, the extent of the risk posed by the new vulnerabilities in the target industrial control system may be checked. That is, the vulnerabilities are extracted using various keywords related to the target industrial control system, and a realistic risk for the target industrial control system is calculated by taking the characteristics of the operating environment of the target industrial control system into account, whereby the level of the risk may be made known.

Also, although not illustrated in FIG. 3, in the method for calculating a risk for an industrial control system according to an embodiment of the present invention, various kinds of information generated in the above-described process of calculating a risk are stored in a separate storage module.

Through the above-described method for calculating a risk for an industrial control system, a realistic risk of a newly discovered vulnerability may be calculated by reflecting the characteristics of the operating environment of the industrial control system that is currently being operated.

Also, information about how the newly discovered vulnerability can be exploited for an attack in the industrial control system may be provided, and the risk thereof may be quantified in consideration of the characteristics of the operating environment of the system such that general users are aware of the risk level, whereby the operator of the industrial control system may intuitively recognize the expected effect of the new vulnerability on the system managed by the operator.

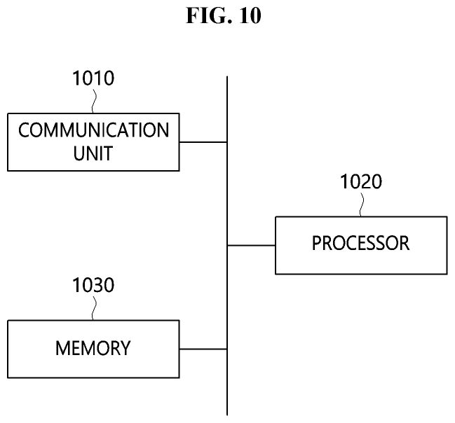

FIG. 10 is a block diagram illustrating an apparatus for calculating a risk for an industrial control system according to an embodiment of the present invention.

Referring to FIG. 10, the apparatus for calculating a risk for an industrial control system according to an embodiment of the present invention includes a communication unit 1010, a processor 1020, and memory 1030.

The communication unit 1010 functions to transmit and receive information required for calculating a risk for an industrial control system through a communication network. Particularly, the communication unit 1010 according to an embodiment of the present invention may receive published vulnerabilities through the Internet, and may transmit a finally calculated targeted risk for the target industrial control system to an operator or an operator module.

The processor 1020 collects at least one keyword based on the published vulnerabilities, and generates an attack vector corresponding to the at least one keyword.

Here, the published vulnerabilities may be automatically collected over the Internet in a periodic or aperiodic manner. For example, vulnerability information provided by various organizations, including a National Vulnerability Database (NVD) managed by the National Institute of Standards and Technology (NIST) in the U.S., may be collected.

Here, because the collected vulnerability information may have various forms and formats, the vulnerability collected through the Internet may be parsed to take a form from which a keyword can be extracted. For example, in the present invention, the vulnerability information may be processed in a JSON or CSV format.

Here, the attack vector defined in the present invention may include information about the steps that need to be performed in order for an attack using the published vulnerability to succeed. This concept is autonomously defined, developed and used in the present invention, and may have definition different from that of a concept having a similar name.

Accordingly, the present invention may use a vulnerability target, description information about the vulnerability itself, and the risk of the vulnerability, which are included in the parsed vulnerability information, as important information for generating an attack vector.

Here, the at least one keyword may be extracted from the published vulnerability based on parameters used in the predefined Common Vulnerability Scoring System (CVSS).

Here, the published vulnerability may include at least one of a method for accessing a vulnerability target, the vulnerability target, and detailed information on the vulnerability target.

Here, the at least one keyword may include at least one of manufacturer information, product information, product version information, and description information.

For example, vulnerability information published by the National Vulnerability Database (NVD) may generally include a CVE number, a detailed description, a risk level, and information about targets (an operating system, a service, an application, and the like) in which the vulnerability is present, as shown in FIG. 5. Here, the ‘vector’ illustrated in FIG. 5 corresponds to the concept defined and used by the CVSS, and may be different from the attack vector automatically generated in the present invention.

Here, the information capable of being identified in FIG. 5 is the fact that the corresponding vulnerability relates to an attack attempted over a network (AV:N), that is, information about the method of accessing the vulnerability target. Here, this information is insufficient to determine the extent to which the vulnerability will actually affect a specific device. However, the present invention may extract the information about the access method, telling that an attack using the corresponding vulnerability is attempted over a network, as a keyword and use the same for generating an attack vector.

In other words, the AV (attack vector) of the CVSS denotes the access method used for making an attack succeed, and may have any of four values indicating N (Network), A (Adjacent), L (Local) and P (Physical). In the present invention, these values may be extracted as keywords to be used for generating an attack vector.

In another example, the information illustrated in FIG. 6 relates to a description of the vulnerability itself included in the published vulnerability, and keywords related to vulnerable applications or services, that is, keywords related to the vulnerability target, may be extracted therefrom. Referring to the information illustrated in FIG. 6, a Jenkins LDAP Email Plugin is detected as a vulnerability target, and the corresponding information may be extracted as a keyword.

In another example, the information illustrated in FIG. 7 is detailed information on the vulnerability target, and based on the information illustrated in FIG. 7, information such as the name and version of the vulnerable application may be extracted as keywords.

As described above, using the keywords extracted from the information in FIGS. 5 to 7, an attack vector indicating that an attack on a specific version of a Jenkins LDAP email plugin can be attempted over a network and that a configuration problem may result therefrom, may be generated, and this attack vector may be represented as ‘N<-PI<-LL’.

Here, N indicates that the value of the vector provided by the vulnerability is a network, and PI (Physical Interface) and LL (Logical Location) will be described in detail when the characteristics of the operating environment of an industrial control system are described.

FIG. 8 is another example of a published vulnerability, which is different from the example of FIGS. 5 to 7, and the attack vector generated using the vulnerability information illustrated in FIG. 8 may be defined as ‘P<-PI<-PL’. According to this attack vector, because physical access must be possible and a serial port must be provided, the physical location of the actually operated industrial control system may be an important factor for determining the validity of the attack vector.

As described above, the process of generating an attack vector may be performed automatically, and the characteristics matching each keyword collected from the published vulnerability may be continuously updated, whereby a more accurate attack vector may be generated.

Also, the processor 1020 collects information about the characteristics of the operating environment that is currently being used in the target industrial control system.

For example, even if an application of the same version as the version in which a vulnerability is present is running in the industrial control system, the system may not be vulnerable depending on the environment in which the corresponding system is operated. Therefore, in order to reflect this, the present invention may use the characteristics of the operating environment of the target industrial control system.

For example, the characteristics of the operating environment in which an industrial control system is operated may be classified as shown in [Table 1], which was illustrated above.

Here, the operating environment characteristics may be defined in consideration of parameters used in the predefined CVSS such that whether the operating environment characteristics match at least one keyword is determined.

For example, the operating environment characteristics described in [Table 1] may be represented as VS, LS, PI, PL, LL, PM, SC and OS, respectively, and N, A, L and P used in the vector included in the corresponding vulnerability information may be used therewith.

When the attack vector ‘N<-PI<-LL’ derived from the information illustrated in FIGS. 5 to 7 is analyzed based on the above characteristics, it will be understood that the corresponding attack vector is able to attack and affect an industrial control system when the industrial control system has operating environment characteristics in which a physical network interface (PI) is present and in which the system is accessible over a network (LL).

Also, the processor 1020 may search for vulnerabilities capable of affecting the target industrial control system using keywords related to the characteristics of the operating environment of the target industrial control system. Here, the keyword to be used for the search may include at least one of manufacturer information, product information, product version information, and description information, similar to the keyword that is extracted from the vulnerability in order to generate an attack vector.

Accordingly, the manufacturer information, the product information, and the product version information may be retrieved based on the vulnerability target included in the published vulnerability, and the description information may be retrieved based on the detailed information on the vulnerability target included in the published vulnerability. Through the retrieval, vulnerabilities capable of affecting the target industrial control system are identified, and the risk thereof may be calculated.

Also, the processor 1020 calculates the targeted risk of an attack vector in consideration of a vulnerability characteristic matching at least one keyword, among the operating environment characteristics, and a weight applied to the vulnerability characteristic.

Here, the targeted risk may be calculated so as to correspond to an attack path capable of being derived based on the vulnerability characteristic.

Here, the weight may be the weight applied to the operating environment characteristic corresponding to the vulnerability characteristic, among weights applied for the respective operating environment characteristics.

For example, the weights for the respective operating environment characteristics may be assigned as shown in the above-described [Table 2].

Here, the targeted risk may be calculated by adding a first risk, which is calculated by applying the weight applied to the vulnerability characteristic to a general risk attributable to the published vulnerability, and a second risk, which is a potential risk in which the weight applied for each operating environment characteristic is taken into account.

For example, when it is assumed that the first risk is an operational risk score and that the second risk is a potential risk score, the first risk and the second risk may be calculated using Equation (1) and Equation (2), respectively.

AV: N or A

AttackVector*VS*PI*LL

AV: L (the larger value among the following values)

AttackVector*VS*LS*PI*LL

AttackVector*VS*LS*PI*PL

AV: P

AttackVector*VS*PL (1)

w0PM+w1SC+w2OS (2)

Here, the first risk is a value acquired by calculating the risk directly associated with the published vulnerability, and the second risk, which is a potential risk, may be a value acquired by calculating a risk in the situation in which a vulnerable application or service is actually present and there is a high possibility of the risk.

Accordingly, based on the respectively calculated risks, the AttackVector of the finally calculated risk score of the CVSS is replaced, whereby the targeted risk may be finally calculated.

For example, the method of finally calculating a targeted risk by replacing the AttackVector with the risk of each characteristic (characteristic risk) in order to calculate a base score using the method proposed by the present invention may be represented as shown in Equation (3):

8.22*CharacteristicRisk*AttackComplexity*PrivilegeRequired*UserInteraction (3)

Here, values included in vulnerability information provided by the NVD may be used for AttackComplexity, PrivilegeRequired, and UserInteraction.

Also, the processor 1020 provides the targeted risk to the operator module of the target industrial control system.

Because the targeted risk provided through the above-described method reflects all of the characteristics of the operating environment of the target industrial control system therein while retaining the characteristics of the discovered vulnerability itself, it may be very useful in determining whether it is necessary to take a measure in the corresponding operating environment in response to a specific vulnerability.

Also, the processor 1020 may determine that the published vulnerability poses no risk to the target industrial control system when a vulnerability characteristic matching the at least one keyword is not present, among the operating environment characteristics.

Also, the above-described process of calculating a risk is specifically illustrated in FIG. 9.

Referring to FIG. 9, first, whether new vulnerabilities are published is determined at step S905. When no new vulnerability is published, the publication of a new vulnerability may be waited for.

Also, when it is determined at step S905 that new vulnerabilities are published, the published vulnerabilities are collected by downloading a list of the vulnerabilities at step S910, the collected vulnerabilities are parsed at step S920, and an attack vector and a main keyword may be extracted for each of the vulnerabilities.

Using the extracted attack vector and main keyword, an attack vector as defined in the present invention is generated at step S930, and the generated attack vector may be stored in the database along with the vulnerability at step S940. This process may be performed for all of the newly published vulnerabilities.

That is, whether the above process is performed for all of the newly published vulnerabilities is determined at step S950, and when the above process has not been performed for all of the newly published vulnerabilities, the process may be repeatedly performed from step S920.

Through this process, the extent of the risk posed by the new vulnerabilities in the target industrial control system may be checked. That is, the vulnerabilities are extracted using various keywords related to the target industrial control system, and a realistic risk for the target industrial control system is calculated by taking the characteristics of the operating environment of the target industrial control system into account, whereby the level of the risk may be made known.

The memory 1030 stores the attack vector and the operating environment characteristics.

Also, the memory 1030 stores various kinds of information generated in the above-described process of calculating a risk according to an embodiment of the present invention.

According to an embodiment, the memory 1030, which is separate from the apparatus for calculating a risk, may support the function of calculating a risk. Here, the memory 1030 may operate as separate mass storage, and may include a control function for performing operations.

Meanwhile, the apparatus for calculating a risk includes memory installed therein, whereby information may be stored therein. In an embodiment, the memory is a computer-readable medium. In an embodiment, the memory may be a volatile memory unit, and in another embodiment, the memory may be a nonvolatile memory unit. In an embodiment, the storage device is a computer-readable recording medium. In different embodiments, the storage device may include, for example, a hard-disk device, an optical disk device, or any other kind of mass storage.

Using the above-described apparatus for calculating a risk for an industrial control system, a realistic risk of a newly discovered vulnerability may be calculated by reflecting the characteristics of the operating environment of the industrial control system that is currently being operated.

Also, information about how the newly discovered vulnerability can be exploited for an attack in the industrial control system may be provided, and the risk thereof may be quantified in consideration of the characteristics of the operating environment of the system such that general users are aware of the risk level, whereby operators of the industrial control system may intuitively recognize the expected effect of the new vulnerability on the system managed by the operators.

According to the present invention, a realistic risk of a newly discovered vulnerability may be calculated by reflecting the characteristics of the operating environment of an industrial control system that is currently being operated.

Also, the present invention may provide information about how a newly discovered vulnerability can be exploited for an attack in an industrial control system and quantify the risk thereof by taking the characteristics of the operating environment of the industrial control system into account in order to make general users aware of the risk.

Also, the present invention may enable the operator of an industrial control system to intuitively recognize the expected effect of a new vulnerability on the system.

Also, the present invention may easily detect an operating environment that is more likely to be exposed to risk when a vulnerability is exploited, and may significantly reduce the amount of resources to be consumed for elimination of the vulnerability.

As described above, the method for calculating a risk for an industrial control system and the apparatus for the same according to the present invention are not limitedly applied to the configurations and operations of the above-described embodiments, but all or some of the embodiments may be selectively combined and configured, so the embodiments may be modified in various ways.

What is claimed is:

1. A method for calculating a risk for an industrial control system, comprising:
collecting at least one keyword based on a published vulnerability and generating an attack vector corresponding to the at least one keyword;
collecting operating environment characteristics corresponding to an operating environment that is currently being used in a target industrial control system;
calculating a targeted risk for the attack vector in consideration of a vulnerability characteristic matching the at least one keyword, among the operating environment characteristics, and a weight applied to the vulnerability characteristic; and
providing the targeted risk to an operator module of the target industrial control system.

2. The method of claim 1, wherein the at least one keyword is extracted from the published vulnerability based on parameters used in a predefined Common Vulnerability Scoring System (CVSS).

3. The method of claim 1, wherein the published vulnerability includes at least one of a method for accessing a vulnerability target, the vulnerability target, and detailed information of the vulnerability target.

4. The method of claim 1, wherein the targeted risk is calculated so as to correspond to an attack path capable of being derived based on the vulnerability characteristic.

5. The method of claim 1, wherein the weight is a weight applied to an operating environment characteristic corresponding to the vulnerability characteristic, among weights applied for the respective operating environment characteristics.

6. The method of claim 1, wherein the targeted risk is calculated by adding a first risk, which is calculated by applying the weight applied to the vulnerability characteristic to a general risk attributable to the published vulnerability, and a second risk, which is a potential risk in which a weight applied to each of the operating environment characteristics is taken into account.

7. The method of claim 2, wherein the operating environment characteristics are defined in consideration of the parameters used in the predefined CVSS such that whether the operating environment characteristics match the at least one keyword is determined.

8. The method of claim 1, wherein the at least one keyword includes at least one of manufacturer information, product information, product version information, and description information.

9. The method of claim 1, further comprising:
when a vulnerability characteristic matching the at least one keyword is not present, among the operating environment characteristics, determining that the published vulnerability poses no risk to the target industrial control system.

10. An apparatus for calculating a risk for an industrial control system, comprising:
a processor for collecting at least one keyword based on a published vulnerability, generating an attack vector corresponding to the at least one keyword, collecting operating environment characteristics corresponding to an operating environment that is currently being used in a target industrial control system, calculating a targeted risk for the attack vector in consideration of a vulnerability characteristic matching the at least one keyword, among the operating environment characteristics, and a weight applied to the vulnerability characteristic, and providing the targeted risk to an operator module of the target industrial control system; and
memory for storing the attack vector and the operating environment characteristics.

11. The apparatus of claim 10, wherein the at least one keyword is extracted from the published vulnerability based on parameters used in a predefined Common Vulnerability Scoring System (CVSS).

12. The apparatus of claim 10, wherein the published vulnerability includes at least one of a method for accessing a vulnerability target, the vulnerability target, and detailed information of the vulnerability target.

13. The apparatus of claim 10, wherein the targeted risk is calculated so as to correspond to an attack path capable of being derived based on the vulnerability characteristic.

14. The apparatus of claim 10, wherein the weight is a weight applied to an operating environment characteristic corresponding to the vulnerability characteristic, among weights applied for the respective operating environment characteristics.

15. The apparatus of claim 10, wherein the targeted risk is calculated by adding a first risk, which is calculated by applying the weight applied to the vulnerability characteristic to a general risk attributable to the published vulnerability, and a second risk, which is a potential risk in which a weight applied to each of the operating environment characteristics is taken into account.

16. The apparatus of claim 11, wherein the operating environment characteristics are defined in consideration of the parameters used in the predefined CVSS such that whether the operating environment characteristics match the at least one keyword is determined.

17. The apparatus of claim 10, wherein the at least one keyword includes at least one of manufacturer information, product information, product version information, and description information.

18. The apparatus of claim 10, wherein, when a vulnerability characteristic matching the at least one keyword is not present, among the operating environment characteristics, the processor determines that the published vulnerability poses no risk to the target industrial control system.
